(19) United States
(12) Patent Application Publication
(10) Pub. No.: US 2006/0123217 A1
(43) Pub. Date: Jun. 8, 2006

(54) Utilization zones for automated resource management

(75) Inventors: Dean Joseph Burdick, Austin, TX (US); Marcos A. Villarreal, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/006,124

(22) Filed: Dec. 7, 2004

(51) Int. Cl. G06F 12/00

(52) U.S. Cl. 711/173

(57) ABSTRACT

A client/server model is provided for automatically monitoring and assigning resources in a logically partitioned environment. Each partition includes a client application that monitors that partition's resource utilization. The client application gathers resource utilization metrics and sends resource status notifications to a server application on a periodic basis. The server application runs on either a partition or an outside workstation. The server application waits for resource status notifications from clients and, based on these notifications, categorizes the partitions into utilization zones. The server then reassigns resources from partitions in a low utilization zone to partitions in high utilization zones.

### BACKGROUND OF THE INVENTION

1. Technical Field

The present invention relates to data processing and, in particular, to logically partitioned data processing systems. Still more particularly, the present invention provides a method, apparatus, and program for automated resource management in a logically partitioned data processing system through utilization zones.

2. Description of Related Art

Large symmetric multi-processor data processing systems may be partitioned and used as multiple smaller systems. Examples of such systems include IBM eServer™ P690 available from International Business Machines Corporation, DHP9000 Superdome Enterprise Server available from Hewlett-Packard Company, and the Sun Fire™ 15K server available from Sun Microsystems, Inc. These systems are often referred to as logical partitioned (LPAR) data processing systems. A logical partitioned functionality within a data processing system allows multiple copies of a single operating system or multiple heterogeneous operating systems to be simultaneously run on a single data processing system platform. A partition, within which an operating system image runs, is assigned a non-overlapping subset of the platform's physical resources. These platform allocable resources include one or more architecturally distinct processors with their interrupt management area, regions of system memory, and input/output (I/O) adapter bus slots. The partition's resources are represented by the platform's firmware to the operating system image.

Each distinct operating system or image of an operating system running within a platform is protected from each other such that software errors on one logical partition cannot affect the correct operation of any of the other partitions. This protection is provided by allocating a disjointed set of platform resources to be directly managed by each operating system image and by providing mechanisms for insuring that the various images cannot control any resources that have not been allocated to that image. Furthermore, software errors in the control of an operating system's allocated resources are prevented from affecting the resources of any other image. Thus, each image of the operating system or each different operating system directly controls a distinct set of allocable resources within the platform.

Often times in an LPAR data processing system resources are under or over utilized. Constant manual management is required to monitor the resource utilization and assign resources accordingly to provide optimum utilization. For example, a partition may be running with one central processing unit (CPU) with utilization at 100%. By allocating another CPU to this partition, an administrator may provide additional resources to help with the workload.

However, where to get the additional resources may also pose a problem. If all resources are currently assigned to other partitions, then one must decide from where to take resources and to where they should be assigned. Thus, a system administrator must log into each partition and record the utilization and then compare utilization statistics to each other partition. This manual process is time consuming and costly.

### SUMMARY OF THE INVENTION

The present invention recognizes the disadvantages of the prior art and provides a client/server model for automatically monitoring and assigning resources in a logically partitioned environment. Each partition includes a client application that monitors that partition's resource utilization. The client application gathers resource utilization metrics and sends resource status notifications to a server application on a periodic basis. The server application runs on either a partition or an outside workstation. The server application waits for resource status notifications from clients and, based on these notifications, categorizes the partitions into utilization zones. The server then reassigns resources from partitions in a low utilization zone to partitions in high utilization zones.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the present invention may be implemented;

FIG. 2 is a block diagram of an exemplary logical partitioned platform in which the present invention may be implemented;

FIG. 3 is a block diagram illustrating a dynamic resource management system within a logically partitioned data processing system in accordance with an exemplary embodiment of the present invention;

FIGS. 4A-4C illustrate example partitions sorted into linked lists based on utilization zones in accordance with an exemplary embodiment of the present invention;

FIG. 5 is a flowchart illustrating the operation of a monitoring client in accordance with an exemplary embodiment of the present invention; and

FIG. 6 is a flowchart illustrating the operation of a monitoring and resource management server in accordance with an exemplary embodiment of the present invention.

### DETAILED DESCRIPTION OF THE PREFERRED EMBODIMENT

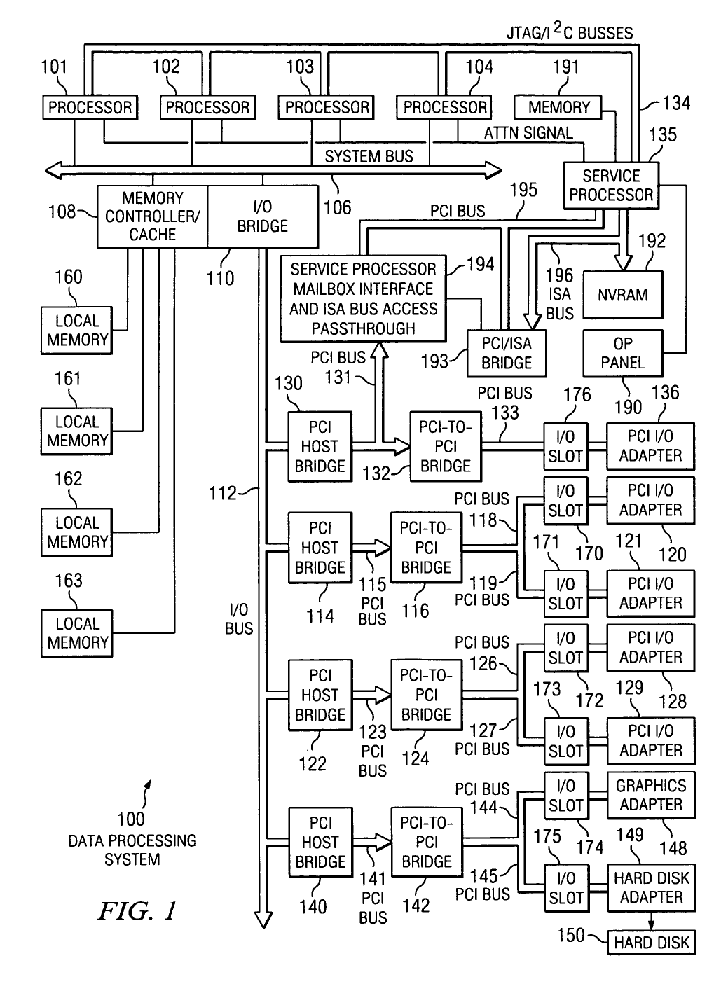

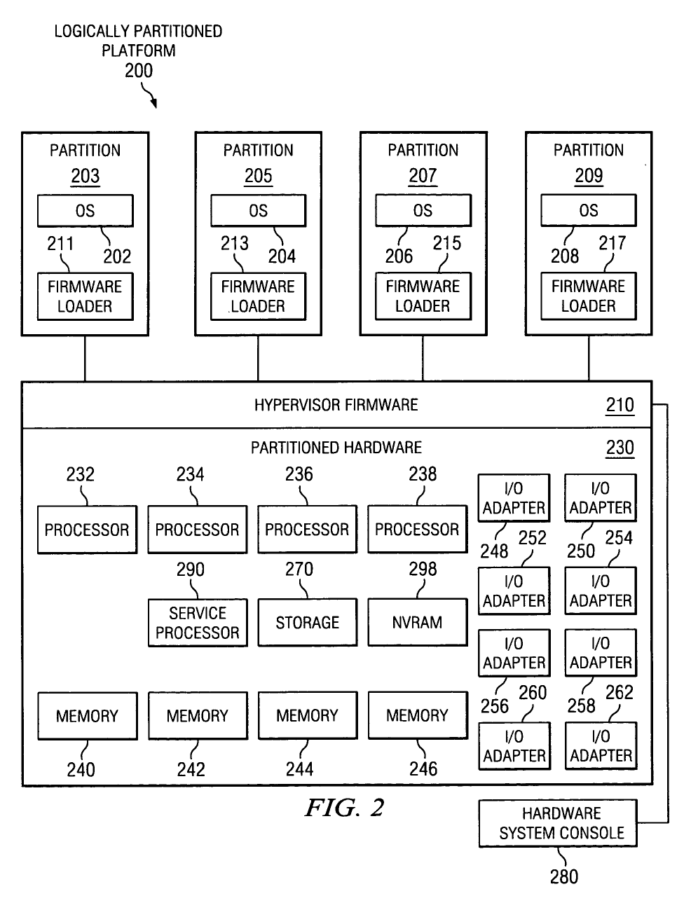

The present invention provides a method, apparatus and computer program product for automated resource management in a logically partitioned data processing system through utilization zones. The data processing device may be a stand-alone computing device or may be a distributed data processing system in which multiple computing devices are utilized to perform various aspects of the present invention. Therefore, the following FIGS. 1 and 2 are provided as exemplary diagrams of data processing environments in which the present invention may be implemented. It should be appreciated that FIGS. 1 and 2 are only exemplary and are not intended to assert or imply any limitation with regard to the environments in which the present invention may be implemented. Many modifications to the depicted environments may be made without departing from the spirit and scope of the present invention.

With reference now to the figures, and in particular with reference to FIG. 1, a block diagram of a data processing system in which the present invention may be implemented is depicted. Data processing system 100 may be a symmetric multiprocessor (SMP) system including a plurality of processors 101, 102, 103, and 104 connected to system bus 106. For example, data processing system 100 may be an IBM eServer™ system, a product of International Business Machines Corporation in Armonk, N.Y., implemented as a server within a network. Also connected to system bus 106 is memory controller/cache 108, which provides an interface to a plurality of local memories 160-163. I/O bus bridge 110 is connected to system bus 106 and provides an interface to I/O bus 112. Memory controller/cache 108 and I/O bus bridge 110 may be integrated as depicted.

Data processing system 100 is a logical partitioned (LPAR) data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 provides a connection for a display device (not shown), while hard disk adapter 149 provides a connection to control hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and memory from local memories 160-163 is assigned to one of the three partitions. In these examples, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and I/O adapters 120, 128, and 129 may be assigned to logical partition PI; processors 102-103, some portion of memory from local memories 160-163, and PCI I/O adapters 121 and 136 may be assigned to partition P2; and processor 104, some portion of memory from local memories 160-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX®) operating system may be executing within partition P1, a second instance (image) of the AIX® operating system may be executing within partition P2, and a Windows XP™ operating system may be operating within logical partition P3. Windows XP™ is a product and trademark of Microsoft Corporation of Redmond, Wash.

Peripheral component interconnect (PCI) host bridge 114 connected to I/O bus 112 provides an interface to PCI local bus 115. A number of PCI input/output adapters 120-121 may be connected to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations will support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 is connected to a plurality of PCI I/O adapters 128-129. PCI I/O adapters 128-129 may be connected to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. In this manner, data processing system 100 allows connections to multiple network computers.

A memory mapped graphics adapter 148 inserted into I/O slot 174 may be connected to I/O bus 112 through PCI bus 144, PCI-to-PCI bridge 142, PCI bus 141 and PCI host bridge 140. Hard disk adapter 149 may be placed into I/O slot 175, which is connected to PCI bus 145. In turn, this bus is connected to PCI-to-PCI bridge 142, which is connected to PCI host bridge 140 by PCI bus 141.

A PCI host bridge 130 provides an interface for a PCI bus 131 to connect to I/O bus 112. PCI I/O adapter 136 is connected to I/O slot 176, which is connected to PCI-to-PCI bridge 132 by PCI bus 133. PCI-to-PCI bridge 132 is connected to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through logic 194 forwards PCI accesses destined to the PCI/ISA bridge 193. NVRAM storage 192 is connected to the ISA bus 196. Service processor 135 is coupled to service processor mailbox interface and ISA bus access pass-through logic 194 through its local PCI bus 195. Service processor 135 is also connected to processors 101-104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 are connected together to an interrupt input signal of the service processor. The service processor 135 has its own local memory 191, and has access to the hardware OP-panel 190.

When data processing system 100 is initially powered up, service processor 135 uses the JTAG/I²C busses 134 to interrogate the system (host) processors 101-104, memory controller/cache 108, and I/O bridge 110. At completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases host processors 101-104 for execution of the code loaded into local memory 160-163. While host processors 101-104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 is responsible for saving and reporting error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer™ iSeries™ Model 840 system available from International Business Machines Corporation. Such a system may support logical partitioning using an OS/400® operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

With reference now to FIG. 2, a block diagram of an exemplary logical partitioned platform is depicted in which the present invention may be implemented. The hardware in logical partitioned platform 200 may be implemented as, for example, data processing system 100 in FIG. 1. Logical partitioned platform 200 includes partitioned hardware 230, operating systems 202, 204, 206, 208, and hypervisor 210. Operating systems 202, 204, 206, and 208 may be multiple copies of a single operating system or multiple heterogeneous operating systems simultaneously running on platform 200. These operating systems may be implemented using the OS/400® operating system and are designed to interface with a hypervisor. Operating systems 202, 204, 206, and 208 are located in partitions 203, 205, 207, and 209, respectively.

Additionally, these partitions also include firmware loaders 211, 213, 215, and 217. Firmware loaders 211, 213, 215, and 217 may be implemented using IEEE-1275 Standard Open Firmware and runtime abstraction software (RTAS), for example, which is available from International Business Machines Corporation. When partitions 203, 205, 207, and 209 are instantiated, the hypervisor's partition manager loads a copy of the open firmware into each partition. The processors associated or assigned to the partitions are then dispatched to the partition's memory to execute the partition firmware.

Partitioned hardware 230 includes a plurality of processors 232-238, a plurality of system memory units 240-246, a plurality of input/output (I/O) adapters 248-262, and a storage unit 270. Partitioned hardware 230 also includes service processor 290, which may be used to provide various services, such as processing of errors in the partitions. Each of the processors 232-238, memory units 240-246, NVRAM storage 298, and I/O adapters 248-262 may be assigned to one of multiple partitions within logical partitioned platform 200, each of which corresponds to one of operating systems 202, 204, 206, and 208.

Hypervisor firmware 210 performs a number of functions and services for partitions 203, 205, 207, and 209 to create and enforce the partitioning of logical partitioned platform 200. Hypervisor 210 is a firmware implemented virtual machine identical to the underlying hardware. Hypervisor software is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM). Thus, hypervisor 210 allows the simultaneous execution of independent OS images 202, 204, 206, and 208 by virtualizing all the hardware resources of logical partitioned platform 200.

Operations of the different partitions may be controlled through a hardware management console, such as hardware management console 280. Hardware management console 280 is a separate data processing system from which a system administrator may perform various functions including reallocation of resources to different partitions.

Often times in an LPAR data processing system resources are under or over utilized. Constant manual management is required to monitor the resource utilization and assign resources accordingly to provide optimum utilization. For example, partition 203 may be running with only processor 232 with utilization at 100%. By allocating another processor to this partition, an administrator may provide additional resources to help with the workload.

However, where to get the additional resources may also pose a problem. If all resources are currently assigned to other partitions, then one must decide from where to take resources and to where they should be assigned. Thus, a system administrator must log into each partition and record the utilization and then compare utilization statistics to each other partition. This manual process is time consuming and costly.

The present provides a client/server model for automatically monitoring and assigning resources in a logically partitioned environment. Each partition includes a client application that monitors that partition's resource utilization. The client application gathers resource utilization metrics and sends resource status notifications to a server application on a periodic basis. The server application runs on either a partition or an outside workstation. The server application waits for resource status notifications from clients and, based on these notifications, categorizes the partitions into utilization zones. The server then reassigns resources from partitions in a low utilization zone to partitions in high utilization zones.

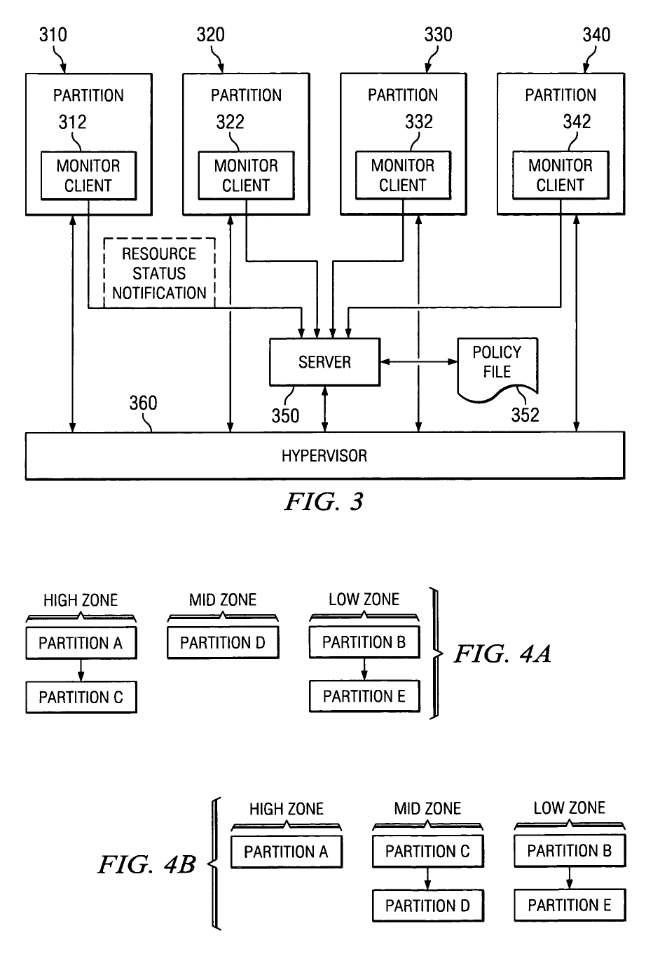

FIG. 3 is a block diagram illustrating a dynamic resource management system within a logically partitioned data processing system in accordance with an exemplary embodiment of the present invention. Hypervisor 360 allows the simultaneous execution of independent OS images by virtualizing all the hardware resources of logical partitions 310, 320, 330, and 340. Monitor clients 312, 322, 332, 334 run on partitions 310, 320, 330, 340, respectively. Server 350 may run on one of partitions 310, 320, 330, 340, another partition (not shown) within the data processing system, or on an outside terminal, such as hardware system console 280 in FIG. 2.

Server application 350 acts as a system administrator. Policy file 352 describes the partitions to monitor and utilization zone thresholds to be applied to the partitions. These thresholds determine the state of resource usage. A communication session is established with each of the partitions. Server 350 and monitor clients 312, 322, 332, 342 may be, for example, a Resource Monitoring and Control (RMC) class. There are known types of RMC classes; however, a specialized class may be derived for automatic and dynamic resource allocation in a LPAR environment. Upon connection, server 350 may send the thresholds to the partitions to be monitored and these thresholds are set in each monitor client instance.

When a monitor client, such as monitor client 312, generates a resource status notification event, server 350 sorts the partition in a linked list representing the appropriate zone based on the event. The linked list is sorted by the actual resource utilization metric. As a specific example, a high zone is sorted in descending order, a mid zone is sorted in descending order, and a low zone is sorted in ascending order.

When a partition is placed on either the high or low zone list, server 350 checks to see if resources can be reallocated. If there is a partition on the high zone list, then server 350 checks the low zone list to see if resources can be moved from the low partition to the high partition. Once resources are allocated/deallocated, the two partitions in question are removed from their respective lists. This process is repeated until either the high zone list or the low zone list is empty.

If a partition is already in one zone and server 350 receives an event (notification) that would place the partition in another zone, then server 350 first removes the partition from its current zone list and then places the partition on the appropriate utilization zone list. If while a partition is already in once zone and server 350 receives an event that places the partition in the same zone, then server 350 resorts the list with the partition's new utilization metric.

Each client, such as monitor client 312, runs on a partition, such as partition 310. Monitor clients 312, 322, 332, 342 may be, for example a RMC resource class that is modified to include the automated resource management with utilization zones in accordance with the exemplary aspects of the present invention. Monitor client 312, for example, gathers resource utilization metrics, such as CPU usage, memory usage, I/O adapter usage, etc., on a periodic basis. For example, monitor client 312 may wake itself up every ten seconds, for instance, and gather resource utilization metrics. The monitoring interval may be selected based on the implementation.

Based on the gathered utilization metrics and thresholds received from server 350, as defined in policy file 352, the monitor client notifies the server of the partition's current state. If the utilization is below a low threshold, the monitor client requests for server 350 to remove resources from the partition. On the other hand, if the utilization is above a high threshold, the monitor client requests for server 350 to assign more resources to the partition. If the utilization is between the low threshold and the high threshold, the monitor client reports that the current allocation for the partition is sufficient.

Server 350 may run on a management console, such as hardware system console 280 in FIG. 2. In this case server 350 makes resource allocation and deallocation requests to hypervisor 360. In an alternate embodiment, server 350 runs on a partition in the logically partitioned data processing system. In this instance, server 350 requests allocation and deallocation of resources to hypervisor 360 through a management console (not shown).

The low threshold and the high threshold may be selected based on the implementation. For example, the low threshold may be set to 40% while the high threshold may be set to 90%. However, the specific conditions of the LPAR data processing system may dictate that the thresholds must be modified to achieve more of a balance in resource allocation. In other words, the low threshold and high threshold should be set to ensure that the majority of partitions spend the majority of their time in the mid zone. The administrator may modify policy 352, through a user interface at hardware system console 280 in FIG. 2, for example, at any time to attempt to achieve this balance.

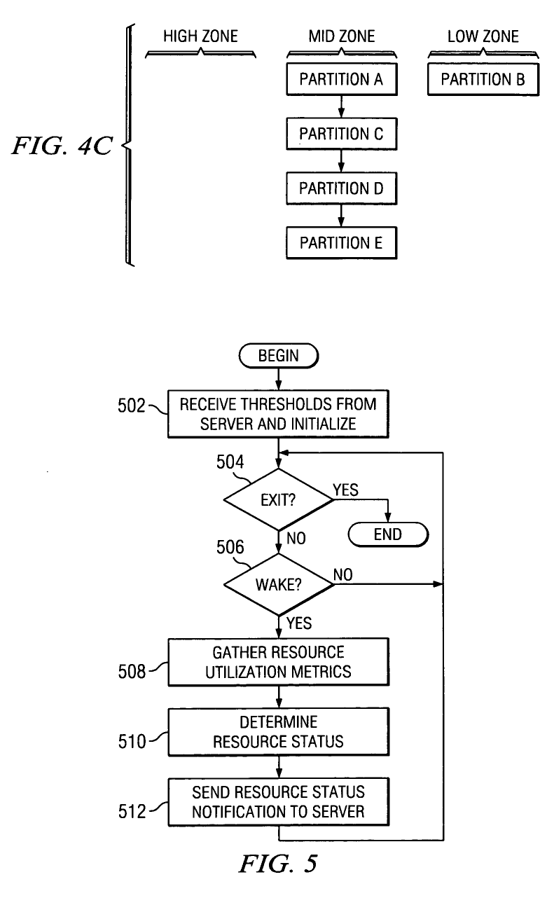

FIGS. 4A-4C illustrate example partitions sorted into linked lists based on utilization zones in accordance with an exemplary embodiment of the present invention. The server application receives resource status notifications from the monitoring clients of the partitions to be monitored. The server then categorizes the partitions into utilization zones and then forms a linked list for each utilization zone. In the examples shown in FIGS. 4A-4C, there are three utilization zones, a high zone, a mid zone, and a low zone. However, more or fewer utilization zone may be used depending upon the implementation. For example, two zones may be used to dynamically allocate resources to partitions to implement a fairness policy where each partition may receive more resources than others for a slice of time as another example, five zones may be implemented such that a more drastic resource allocation may take place from the lowest zone to the highest zone.

In FIG. 4A, partition A and partition C are in the high zone, meaning their resource utilization is above the high threshold. The high zone linked list is sorted in descending order; therefore, the resource utilization of partition A is higher than the resource utilization of partition C. Also, partition B and partition E are in the low zone, meaning their resource utilization is below the low threshold. The low zone linked list is sorted in ascending order; therefore, the resource utilization of partition B is lower than the resource utilization of partition E. Partition D is in the middle utilization zone, meaning its resource utilization is between the low threshold and the high threshold.

Since partition B is has the lowest resource utilization and partition A has the highest resource utilization, the server application then attempts to deallocate resources from partition B and assign them to partition A. The server then removes partition B from the low zone linked list and removes partition A from the high zone linked list. Similarly, the server attempts to deallocate resources from partition E and assign them to partition C. Then, the server removes partition E from the low zone linked list and removes partition C from the high zone linked list.

The next time resource utilization metrics are gathered, the server receives notification that partition C is in the mid zone, as shown in FIG. 4B. That is, the resource utilization for partition C is between the low threshold and the high threshold. The mid zone linked list is sorted in descending order; therefore, the resource utilization of partition C is higher than the resource utilization of partition D. Based on the gathered utilization metrics in this example, partition B and partition E remain in the low utilization zone.

Since partition B is has the lowest resource utilization and partition A has the highest resource utilization, the server application then attempts to deallocate resources from partition B and assign them to partition A. The server then removes partition B from the low zone linked list and removes partition A from the high zone linked list. Then, the next time resource utilization metrics are gathered, the server receives notification that partition A and partition E are now in the mid zone, as shown in FIG. 4C. Since the high zone linked list is empty, no allocation/deallocation is necessary.

FIG. 5 is a flowchart illustrating the operation of a monitoring client in accordance with an exemplary embodiment of the present invention. Operation begins and the client receives thresholds from the server application and initializes (block 502). Then, a determination is made as to whether an exit condition exists (block 504). An exit condition may exist, for example, when the partition is deprovisioned or when the data processing system shuts down. If an exit condition exists, operation ends.

If an exit condition does not exist in block 504, a determination is made as to whether to wake up and gather statistics (block 506). This determination may be made, for example, by determining whether a monitoring interval expires. A monitoring interval may be set in the initialization in block 502 and may be defined by a policy at the server. The monitor client may also wake in response to another even, such as an error condition due to insufficient resources, for example. If the monitor client does not wake in block 506, operation returns to block 504 to determine whether an exit condition exists.

If the monitor client wakes in block 506, the monitor client gathers resource utilization metrics (block 508), determines a resource status (block 510), and sends a resource status notification to the server (block 512). Thereafter, operation returns to block 504 to determine whether an exit condition exists.

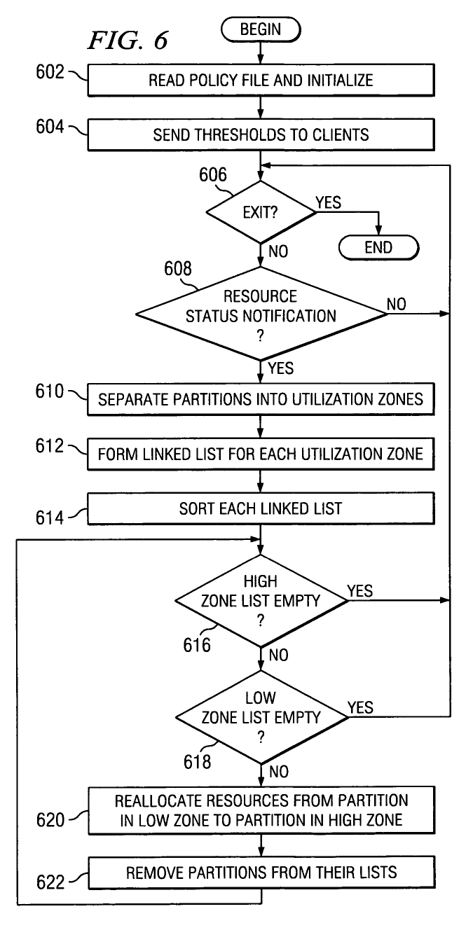

FIG. 6 is a flowchart illustrating the operation of a monitoring and resource management server in accordance with an exemplary embodiment of the present invention. Operation begins and the server reads a policy file and initializes (block 602). As described above, the policy file may define which partitions are to be monitored, thresholds for utilization zones, a monitoring interval, and other information used to monitor and manage resources. Then, the server sends thresholds to monitoring clients (block 604).

Next, a determination is made as to whether an exit condition exists (block 606). An exit condition may exist, for example, when the data processing system shuts down. If an exit condition does exist, operation ends. If an exit condition does not exist in block 606, the server determines whether one or more resource status notifications are received (block 608). If a resource status notification is not received, operation returns to block 606 to determine whether an exit condition exists.

If a resource status notification is received in block 608, the server separates the partitions into utilization zones (block 610). Then, the server forms a linked list for each utilization zone (block 612) and sorts each linked list (block 614). Next, a determination is made as to whether the high zone is empty (block 616). If the high zone list is empty, then no reallocation of resources is necessary and operation returns to block 606 to determine whether an exit condition exists.

If the high zone list is not empty in block 616, a determination is made as to whether the low zone list is empty (block 618). If the low zone list is empty, then there are no unused resources to reallocate to the partitions in the high zone list and operation returns to block 606 to determine whether an exit condition exists.

If the low zone list is not empty in block 618, then the server reallocates resources from the partition in the low zone with the lowest utilization to the partition in the high zone with the highest utilization (block 620). Next, the server removes these partitions from their respective lists (block 622) and operations returns to blocks 616 and 618 to determine whether the high zone list or the low zone list is empty. The server then continues to reallocate resources from partitions in the low zone list to partitions in the high zone list until either the high zone list or the low zone list is empty.

Thus, the present invention solves the disadvantages of the prior art by providing a client/server model for automatically monitoring and assigning resources in a logically partitioned environment. Each partition includes a client application that monitors that partition's resource utilization. The client application gathers resource utilization metrics and sends resource status notifications to a server application on a periodic basis. The server application runs on either a partition or an outside workstation. The server application waits for resource status notifications from clients and, based on these notifications, categorizes the partitions into utilization zones. The server then reassigns resources from partitions in a low utilization zone to partitions in high utilization zones.

The client/server model of the present invention allows automatic resource management and dynamic allocation without manual intervention by an administrator. The administrator may then spend his or her valuable time on other duties. Furthermore, since partitions are more frequently monitored and resources are more intelligently allocated, the data processing system is allowed to perform more efficiently, thus better satisfying service level agreements.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing resources in a logically partitioned data processing system, the method comprising:
receiving resource utilization status information from partitions;
categorizing the partitions into utilization zones; and
dynamically reallocating resources from a low utilization partition in a low utilization zone to a high utilization partition in a high utilization zone.

2. The method of claim 1, wherein receiving resource utilization status information includes receiving a resource utilization status notification from a monitor client application running in a given partition.

3. The method of claim 2, wherein the resource utilization status notification identifies a utilization zone of the given partition.

4. The method of claim 3, wherein categorizing the partitions into utilization zones includes:
forming a list for each utilization zone; and
sorting the list for each utilization zone.

5. The method of claim 4, further comprising:
after dynamically reallocating resources from a low utilization partition in a low utilization zone to a high utilization partition in a high utilization zone, removing the low utilization partition from the list of the low utilization zone and removing the high utilization partition from the list of the high utilization zone.

6. The method of claim 5, further comprising:
repeating the reallocation of resources until either the list of the high utilization zone or the list of the low utilization zone is empty.

7. The method of claim 1, wherein the utilization zones include a low utilization zone, a mid utilization zone, and a high utilization zone.

8. The method of claim 1, wherein the method is performed by a server application running on one of a hardware management console and a partition within the logically partitioned data processing system.

9. An apparatus for managing resources in a logically partitioned data processing system, the apparatus comprising:
a plurality of monitoring client applications running in partitions within the logically partitioned data processing system;
a server application; and
a hypervisor,
wherein each monitoring client application collects resource utilization statistics for its respective partition, identifies a utilization zone for its respective partition, and sends notification of the utilization zone to the server application;
wherein the server application receives utilization zone notifications from each monitoring client application, categorizes the partitions into utilization zones, and dynamically reallocates resources from a low utilization partition in a low utilization zone to a high utilization partition in a high utilization zone.

10. The apparatus of claim 9, wherein the server application categorizes the partitions into utilization zones by forming a list for each utilization zone and sorting the list for each utilization zone.

11. The apparatus of claim 10, wherein the server application, after dynamically reallocating resources from a low utilization partition in a low utilization zone to a high utilization partition in a high utilization zone, removes the low utilization partition from the list of the low utilization zone and removing the high utilization partition from the list of the high utilization zone.

12. The apparatus of claim 11, wherein the server application repeats the reallocation of resources until either the list of the high utilization zone or the list of the low utilization zone is empty.

13. The apparatus of claim 9, wherein the utilization zones include a low utilization zone, a mid utilization zone, and a high utilization zone.

14. The apparatus of claim 9, wherein the server application runs on one of a hardware management console and a partition within the logically partitioned data processing system.

15. A computer program product, in a computer readable medium, for managing resources in a logically partitioned data processing system, the computer program product comprising:
instructions for receiving resource utilization status information from partitions;
instructions for categorizing the partitions into utilization zones; and
instructions for dynamically reallocating resources from a low utilization partition in a low utilization zone to a high utilization partition in a high utilization zone.

16. The computer program product of claim 15, wherein the instructions for receiving resource utilization status information includes instructions for receiving a resource utilization status notification from a monitor client application running in a given partition.

17. The computer program product of claim 16, wherein the resource utilization status notification identifies a utilization zone of the given partition.

18. The computer program product of claim 17, wherein the instructions for categorizing the partitions into utilization zones includes:
instructions for forming a list for each utilization zone; and
instructions for sorting the list for each utilization zone.

19. The computer program product of claim 18, further comprising:
instructions for, after dynamically reallocating resources from a low utilization partition in a low utilization zone to a high utilization partition in a high utilization zone, removing the low utilization partition from the list of the low utilization zone and removing the high utilization partition from the list of the high utilization zone.

20. The computer program product of claim 19, further comprising:
instructions for repeating the reallocation of resources until either the list of the high utilization zone or the list of the low utilization zone is empty.
